(19) United States
(12) Patent Application Publication
(10) Pub. No.: US 2011/0175318 A1
(43) Pub. Date: Jul. 21, 2011

(54) CONNECTED SUSPENSION FOR TWO-WHEELED VEHICLES, NAMELY BICYCLES AND MOTORCYCLES

(76) Inventor: Robert Rae, Sligo (IE)

(21) Appl. No.: 13/120,028

(22) PCT Filed: Sep. 11, 2009
(86) PCT No.: PCT/IE2009/000063

§ 371 Date: Mar. 21, 2011

(30) Foreign Application Priority Data
Sep. 22, 2008 (IE) 2008/0753

(51) Int. Cl. B60G 3/12

(52) U.S. Cl. 280/124.164

(57) ABSTRACT

Means of suspension dampening (4, 7) are attached to at least one pivoted member (2, 5) of each suspension, front and rear respectively, where there is further direct attachment to a relative member of the opposing suspension/s at areas of reduced dynamic influence. Motion of members of either suspension will have some of the resulting action transferred by means of the dampening units onto the opposing suspension to the effect of reducing pitching motion in the body of the two-wheeled vehicle when travelling. When cornering forces act to compress the suspension, this displacement of the suspension members can be so arranged as to alter the geometric settings affecting the opposing means of suspension dampening thereby giving different leverage ratios for both cornering and straight-line travelling to the benefit of road-holding.

### BACKGROUND

The invention disclosed herein is generally related to two-wheeled vehicles. More particularly, the present invention relates to a method of connected suspension for two-wheeled vehicles

Two-wheeled vehicles, namely bicycles and motorcycles, have front and/or rear suspension systems with dampening mechanisms to control suspension action which operate independently of each other. At the rear, such dampening mechanisms are, in general, attached to the suspension arm or fork with the other end of the dampening unit attached to the main frame to which vicinity loads from the rear suspension are directed. Such dampening units may or may not be attached to a linkage arrangement that has pivot points on the frame and arm/fork. Telescopic forks are universally used for front suspension with attachment at the steering head where loads from the front suspension are directed towards the vicinity of the frame. Alternative methods of front suspension systems include telescopic forks in conjunction with control arm/s which have a connection to the frame, and mechanical linkage front suspensions that are hinged to the frame without the use of telescopic members. In general, all of the above designs have independent shock absorption units and transmit considerable load from the suspension in the direction of the frame which invariably causes the frame to pitch with the undulations of the surface experienced. This response is in effect due to the large polar moment of inertia that results from absorbing shock loads at a point far from the centre of gravity. Further, when cornering forces act to compress the suspension the leverage ratio and/or suspension dampening settings should ideally alter to compensate for this condition, but with set leverage ratios controlling independent front and rear dampening units, with static dampening settings, this is not possible.

As a general design principle it is desirable that weight and shock loads on the front and rear wheels are not transmitted directly to the body of the two-wheeled vehicle. It is also desirable that such loads are directed in such a manner so to minimise the pitching motion of the body. It is further desirable to provide alternative suspension settings for travelling both in a straight line and cornering. Finally, when methods of springing is/are utilised in suspension systems it can be desirable to have a method of counteracting oscillations resulting from disturbance with the static condition of the spring/s.

Accordingly, it is the object and purpose of this invention to provide an improved suspension arrangement for two-wheeled vehicles.

In this regard it is a more specific objective of the present invention to provide connected suspension that transfers weight load and motion from one suspension system to the other, front to rear, and also, rear to front. It is another objective of the present invention to provide a connected suspension system which will minimise pitching motion in the body of the two-wheeled vehicle. It is yet another objective of the present invention which will provide different suspension leverage ratios for the methods of dampening on the two-wheeled vehicle for both cornering and straight-line travelling. Another objective of this invention is to minimise the disruptive effect of oscillations when springing mechanisms are utilised in the control of suspension systems.

### DETAILED DESCRIPTION OF THE INVENTION

The present invention relates to a two-wheeled vehicle having a body, a front wheel with a method of suspension and a rear wheel with a method of suspension. At least one pivoted suspension member of the front suspension and at least one pivoted suspension member of the rear suspension will be hinged with the body. Means of suspension dampening and/or springing will be attached to at least one pivoted front influential suspension member and means of suspension dampening and/or springing will be attached to at least one pivoted influential rear suspension member with at least one further attachment of said means of dampening and/or springing to member/s of opposing suspension/s. Means of dampening and/or springing interposed between front and rear suspension will have a direct connection to respective relative members. At least one of the said means of dampening and/or springing interposed between members of the front and rear suspension will operate in a linear manner. Controlling means of suspension dampening and/or springing may or may not be attached to pivoted members that hinge with the body. Members which pivot with the body and members which have means of suspension dampening attached may or may not have a direct connection with their respective wheel. Attachment of dampening and/or springing mechanisms will be to an area of dynamic influence on at least one member of the suspension they control, when there is further attachment to a member of the opposing suspension it will be to an area of reduced dynamic influence; namely, in general, at a levered distance from a pivot point on an influential member for an area of dynamic influence, and, to an area close to a pivot point or to another area of limited determining movement for an area of reduced dynamic influence.

In this detailed arrangement, weight load and motion will be transferred from one suspension system onto the opposing, front to rear, and also, rear to front, by means of dampening and/or springing mechanism/s interposed between influential member/s and opposing member/s of reduced dynamic influence with the effect of reducing pitching motion in the body of the two-wheeled vehicle when travelling over uneven surface. When suspension motion is experienced, the connected suspension arrangement can be so configured to transmit a limited amount of load weight and motion onto the opposing suspension thereby affecting both suspensions when only one wheel has experienced an obstacle or any other means to initiate motion of that suspension. In circumstances acting to compress either the front or the rear suspension both suspension systems can be so configured to act in unison to effect a marginal lifting of the centre of gravity of the body of the two-wheeled vehicle and thereby exert greater influence on the means of suspension dampening and/or springing so to have more efficient reaction to any suspension motion, all of which allows the body to remain more stable with less rocking motion when travelling than would be otherwise obtained with conventional designs of suspension arrangements that are not connected. User comfort and road-holding ability of the two-wheeled vehicle can thus be enhanced with a reduction of pitching motion with the body.

The connected suspension system can be so arranged to alter the geometric leverage ratio when an opposing suspension system is compressed to any given degree, in doing so, such compression alters the angle to which the means of dampening and/or springing is/are orientated to the influential member/s to which there is attachment with the effect of altering leverage ratios. With forces, in particular centrifugal and related, acting to compress the suspension when the vehicle is cornering, the leverage ratio can alter for cornering in comparison to straight-line travelling by means of displacement of the suspension unit/s that is/are attached to member/s of the opposing suspension. Road-holding ability can be enhanced where more ideal suspension settings can be achieved in different dynamic conditions when travelling.

Mechanisms and methods of dampening and/or springing can operate in compression, tension, shear, bending or torsion.

Attachment of dampening and/or springing mechanisms to pivoted members may be so arranged to operate in compression, tension, shear, bending or torsion. Since attachment of influential dampening and/or springing methods bearing primary weight and shock loads are transmitted through pivoted suspension members, and not necessarily directly to the body of the two-wheeled vehicle, superior structural strength and stiffness could only be required on the body at points where the suspension members hinge, areas which are in general of considerable strength and stiffness, therewith body construction could be made lighter than otherwise obtained in a conventional design of two-wheeled vehicles.

Connected suspension can function when the dampening and/or springing mechanisms to control front suspension have attachment with front suspension member/s further directly attaching to rear suspension member/s, and, when the dampening and/or springing mechanisms to control rear suspension have attachment with rear suspension member/s further directly attaching to front suspension member/s.

Connected suspension can further function when only front dampening and/or springing mechanisms attach to influential member/s with further direct attachment to rear suspension member/s where rear suspension means of dampening and/or springing do not attach to any member of the front suspension

Further, connected suspension can further function when only rear dampening and/or springing mechanisms attach to influential member/s with further direct attachment to front suspension member/s where front suspension means of dampening and/or springing do not attach to any member of the rear suspension.

When springing methods are utilised in the control of suspension action, opposing spring and/or dampening force and/or resistance can be at a different frequency thereby effectively dampen spring oscillations to the benefit of suspension action. In doing so what is commonly referred to by the term ‘bounce’, associated with suspension motion, will be reduced. Such counteraction used to minimise any oscillation of the spring/s is permitted with all above arrangements of suspension dampening.

These aspects of the present invention are set forth in the accompanying drawings of the invention.

### DRAWINGS

The accompanying drawings are solely to illustrate the invention and are not deemed an accurate depiction of components or mechanisms.

FIG. 1. A side view of a representation of a two-wheeled vehicle 1, with front suspension members 2, pivoting with the body 3, and having a dampening unit 4. Rear suspension members 5, pivoting with the body 6, and having a dampening unit 7, which further connects to front suspension member/s 8.

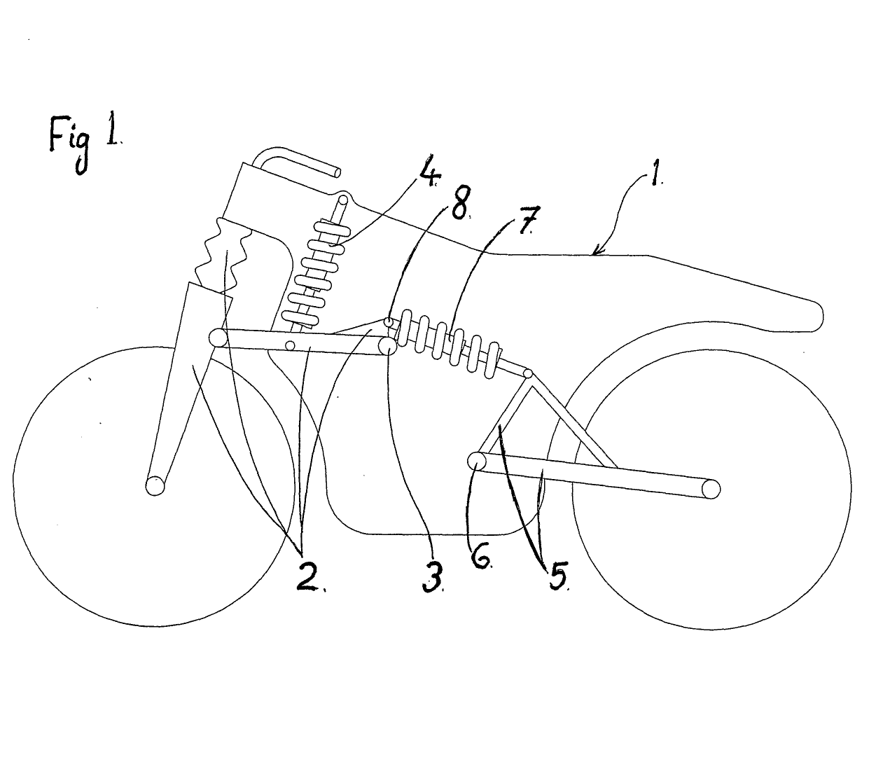

FIG. 2. A side view of a representation of a two-wheeled vehicle 1, with rear suspension members 5, pivoting with the body 6, and having a dampening unit 7. Front suspension members 2, pivoting with the body 3, and having a dampening unit 4, which further connects to rear suspension member/s 9.

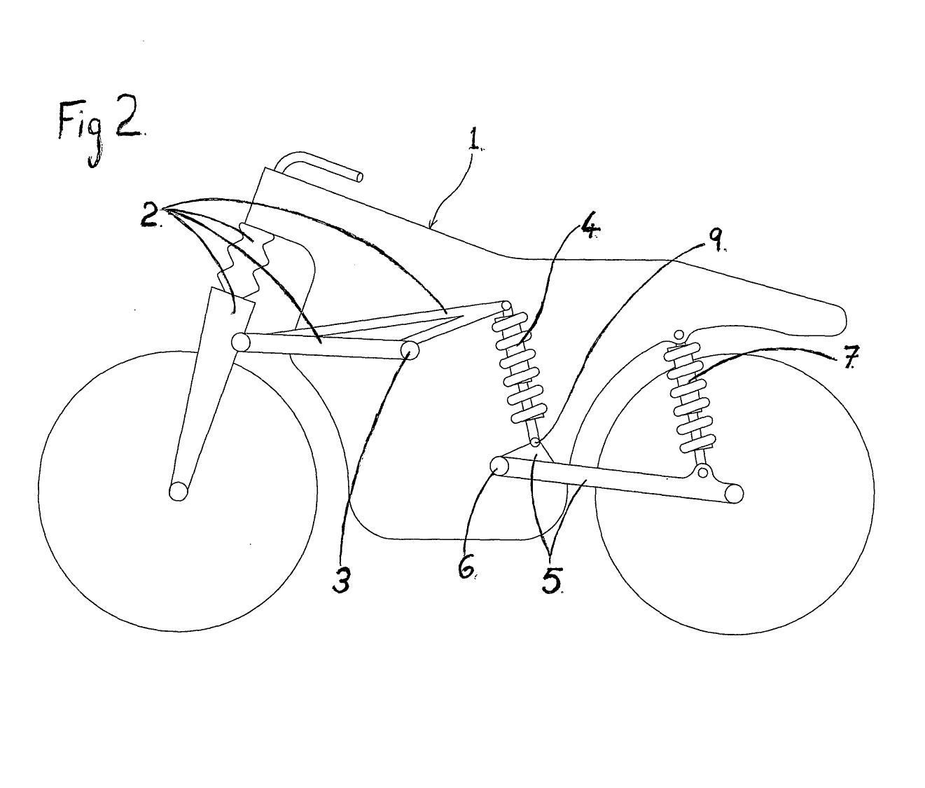

FIG. 3. A side view of a representation of a two-wheeled vehicle 1, with front suspension members 2, pivoting with the body 3, and having a dampening unit 4, which further connects to rear suspension member/s 9. Rear suspension members 5, pivoting with the body 6, and having a dampening unit 7, which further connects to front suspension member/s 8.

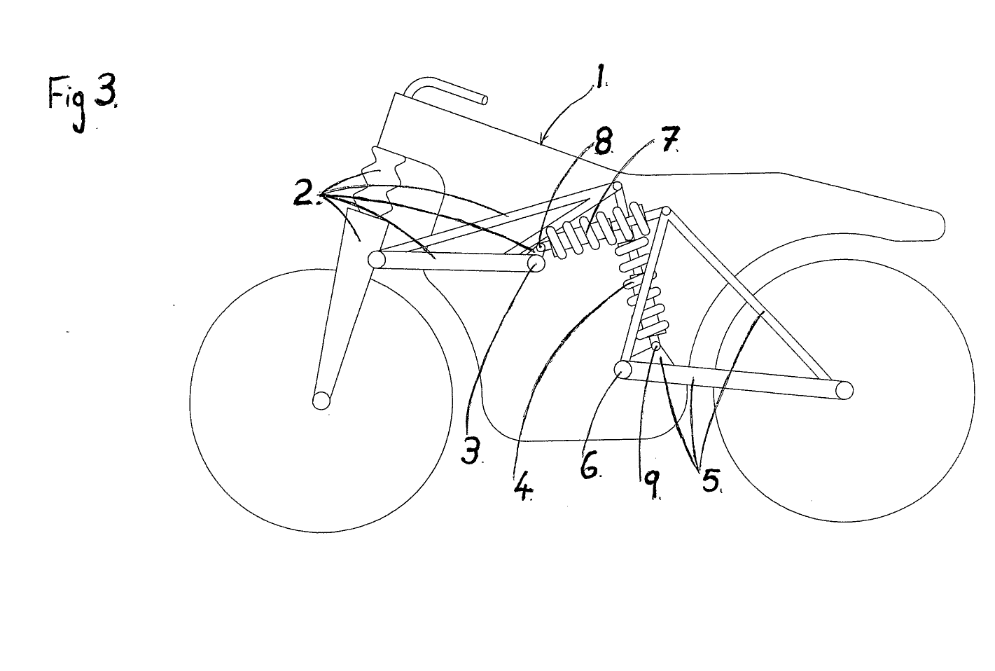

FIG. 4. A side view of a connected suspension system 1, depicting altering of the leverage ratio of a controlling dampening unit 2a and 2b, due to displacement of member/s 3, of the opposing suspension which has attachment of said dampening unit. Broken lines indicate an altered position of opposing suspension member/s and centrelines are utilised to indicate displacement.

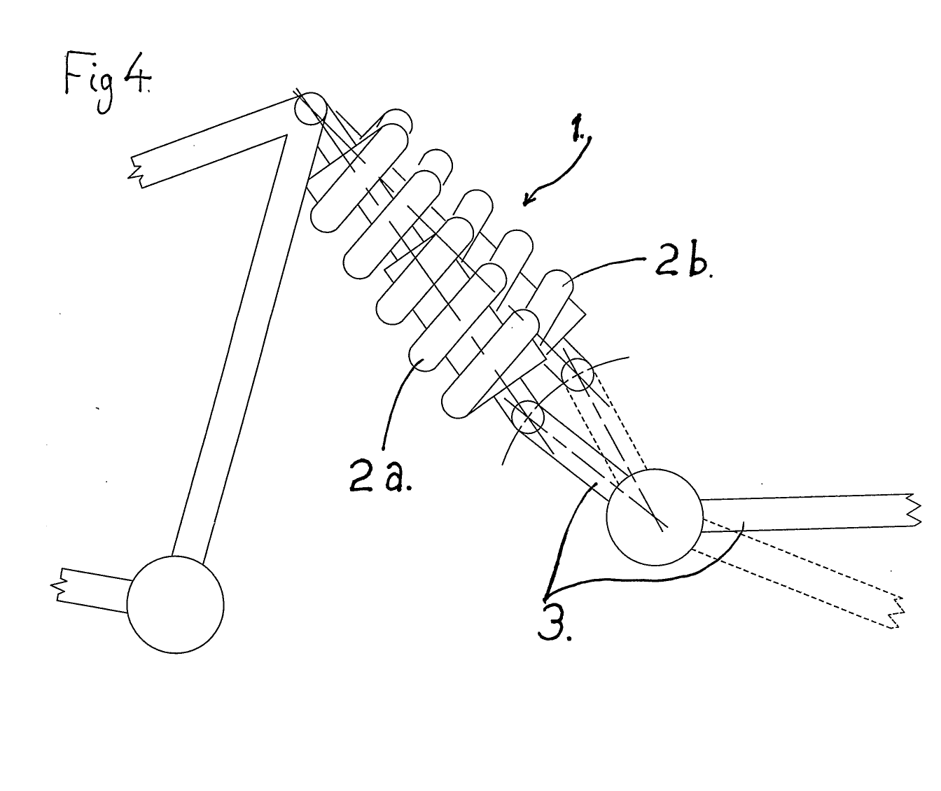

What is claimed is:

1. A connected suspension system between the front and rear suspension members of a two-wheeled vehicle, comprising;
a vehicle body,
a front wheel with a means of suspension where at least one pivoted member hinges with the vehicle body,
a means of dampening/springing controlling front suspension action attached to at least one pivoted member of the front suspension,
a rear wheel with a means of suspension where at least one pivoted member hinges with the vehicle body,
a means of dampening/springing controlling rear suspension action attached to at least one pivoted member of the rear suspension,
and, at least one of the said means of dampening/springing further attached in a direct manner to at least one pivoted member of an opposing suspension.

2. Connected suspension system on a two-wheeled vehicle as defined in claim 1, further comprising; attachment of at least one means of dampening/springing to at least one pivoted member of the front suspension to control suspension action further directly attached to at least one pivoted member of the rear suspension.

3. Connected suspension system on a two-wheeled vehicle as defined in claim 1, further comprising; attachment of at least one means of dampening/springing to at least one pivoted member of the rear suspension to control suspension action further directly attached to at least one pivoted member of the front suspension.

4. Connected suspension system on a two-wheeled vehicle as defined in claim 1, further comprising; attachment of at least one means of dampening/springing to at least one pivoted member of the front suspension to control suspension action further directly attached to at least one pivoted member of the rear suspension, and, attachment of at least one means of dampening/springing to at least one pivoted member of the rear suspension to control suspension action further directly attached to at least one pivoted member of the front suspension.

5. Connected suspension system on a two wheeled vehicle as defined in claims 1, 2, 3 and 4, further comprising; attachment of dampening/springing means to at least one pivoted member of the suspension it controls will be at a substantial levered distance from a pivot point thereof, where, when there is further attachment to a pivoted member of the opposing suspension it will be to an area of reduced dynamic influence, in general, at a distance close to a pivot point on opposing suspension member/s or to another area of limited determining movement.

6. Connected suspension system on a two wheeled vehicle as defined in claims 1, 2, 3, 4, and 5, further comprising; at least one of the said means of dampening/springing with an attachment to at least pivoted member of the front suspension and with an attachment to at least one pivoted member of the rear suspension will operate in a linear manner.

7. Connected suspension system on a two-wheeled vehicle as defined in claims 1, 2, 3, 4, 5, and 6, further comprising; dampening/springing mechanisms can operate in compression, tension, shear, bending or torsion.

8. Connected suspension system on a two-wheeled vehicle as defined in claims 1, 2, 3, 4, 5, and 6, further comprising; dampening/springing mechanisms can be orientated with pivoted suspension member/s to which they attach to operate in compression, tension, shear, bending or torsion.

9. In a two-wheeled vehicle comprising a body, a front wheel with pivoted arm/s controlling suspension motion with attachment of at least one suspension dampening/springing mechanism to said pivoted arm/s and/or related member/s, a rear wheel with pivoted arm/s controlling suspension motion with attachment of at least one suspension dampening/springing mechanism to said pivoted arm/s and/or related member/s, with further attachment in a direct manner of at least one of the said suspension dampening/springing mechanism in the control of respective suspension to a pivoted member/s of an opposing suspension.

10. In a two-wheeled vehicle, as in claim 9, further comprising: attachment of at least one suspension dampening/springing mechanism from a controlling member/s of the front suspension further directly attached to a pivoted member/s of the rear suspension.

11. In a two-wheeled vehicle, as in claim 9, further comprising; attachment of at least one suspension dampening/springing mechanism from a controlling member/s of the rear suspension further directly attached to a pivoted member/s of the front suspension.

12. In a two-wheeled vehicle, as in claim 9, further comprising; attachment of at least one suspension dampening/springing mechanism from a controlling member/s of the front suspension further directly attached to a pivoted member/s of the rear suspension, and, attachment of at least one suspension dampening/springing mechanism from a controlling member/s of the rear suspension further directly attached to a pivoted member/s of the front suspension.
